(19) United States
(12) Patent Application Publication
(10) Pub. No.: US 2024/0157973 A1
(43) Pub. Date: May 16, 2024

(54) SYSTEM AND METHOD FOR DETERMINING A TRAJECTORY FOR A VEHICLE

(71) Applicant: Woven by Toyota, Inc., Tokyo (JP)

(72) Inventors: Stefano Pini, London (GB); Christian Samuel Perone, London (GB); Sergey Zagoruyko, London (GB); Aayush Ahuja, Palo Alto, CA (US); Ana Sofia Rufino Ferreira, Berkeley, CA (US); Moritz Niendorf, Mountain View, CA (US)

(73) Assignee: Woven by Toyota, Inc., Tokyo (JP)

(21) Appl. No.: 17/981,858

(22) Filed: Nov. 7, 2022

Related U.S. Application Data
(60) Provisional application No. 63/352,009, filed on Jun. 14, 2022.

(51) Int. Cl. B60W 60/00; B60W 30/095; B60W 50/00

(52) U.S. Cl. CPC B60W 60/0016; B60W 30/095; B60W 50/0097; B60W 2520/00; B60W 2556/40

(57) ABSTRACT

Described herein are systems and methods for determining a trajectory for a vehicle. In one example, a system includes a processor and a memory in communication with the processor having a planning module. The planning module includes instructions that, when executed by the processor, cause the processor to determine, using a unified neural network based on input information, ego vehicle future trajectories of the ego vehicle and agent future trajectories of one or more agents, select one of the ego vehicle future trajectories as a selected trajectory based on the ego vehicle future trajectories and agent future trajectories using a cost function, and cause the ego vehicle to execute the selected trajectory.

### TECHNICAL FIELD

The subject matter described herein relates, in general, to systems and methods for determining a trajectory for a vehicle.

### BACKGROUND

The background description provided is to present the context of the disclosure generally. Work of the inventor, to the extent it may be described in this background section, and aspects of the description that may not otherwise qualify as prior art at the time of filing are neither expressly nor impliedly admitted as prior art against the present technology.

Some vehicles can pilot themselves from one location to another. These vehicles are commonly referred to as autonomous vehicles and/or self-driving vehicles. Moreover, systems incorporated within autonomous vehicles can receive information regarding the environment, including road layout and the location of other agents such as vehicles, pedestrians, and the like, and plan or otherwise determine an appropriate trajectory for the vehicle to navigate safely in the environment.

Several different methodologies have been utilized to plan the appropriate trajectory. Traditional rule-based systems generally address the planning task by defining progressively larger sets of handcrafted rules. However, adding larger sets of handcrafted rules generally has been proven to scale poorly to complex or unfamiliar driving scenarios. Machine learning-based approaches have been utilized more recently and can learn how to plan appropriate trajectories by training a path planning model appropriately. While machine learning-based approaches can learn more complex behaviors than traditional handcrafted rules, they either approach planning as a unimodal trajectory forecasting problem, lack critical safety checks, and/or are computationally inefficient.

### SUMMARY

This section generally summarizes the disclosure and is not a comprehensive explanation of its full scope or all its features.

In one embodiment, a system includes a processor and a memory in communication with the processor having a planning module. The planning module includes instructions that, when executed by the processor, cause the processor to determine using a unified neural network based on input information, ego vehicle future trajectories of the ego vehicle and agent future trajectories of one or more agents, select one of the ego vehicle future trajectories as a selected trajectory based on the ego vehicle future trajectories and agent future trajectories using a cost function, and cause the ego vehicle to execute the selected trajectory.

In another embodiment, a method for determining a planning trajectory for an ego vehicle may include the steps of determining, using a unified neural network based on input information, ego vehicle future trajectories of the ego vehicle and agent future trajectories of one or more agents, selecting one of the ego vehicle future trajectories as a selected trajectory based on the ego vehicle future trajectories and agent future trajectories using a cost function, and causing the ego vehicle to execute the selected trajectory.

In yet another embodiment, a non-transitory computer-readable medium including instructions that, when executed by a processor, cause the processor to determine, using a unified neural network based on input information, ego vehicle future trajectories of the ego vehicle and agent future trajectories of one or more agents, select one of the ego vehicle future trajectories as a selected trajectory based on the ego vehicle future trajectories and agent future trajectories using a cost function, and cause the ego vehicle to execute the selected trajectory.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one example of an ego vehicle incorporating a system for determining a planning trajectory for the ego vehicle using a unified neural network.

FIG. 2 illustrates a more detailed block diagram of the system for determining the planning trajectory for the ego vehicle of FIG. 1.

FIG. 3 illustrates a process flow for the system that can determine the planning trajectory for the ego vehicle using a unified neural network.

FIG. 4 illustrates one example of the unified neural network utilized by the system of FIG. 2.

FIGS. 5A and 5B illustrate one example of selecting a future trajectory for the ego vehicle from a plurality of trajectories generated by the unified neural network.

FIGS. 6A and 6B illustrate another example of selecting a future trajectory for the ego vehicle from a plurality of trajectories generated by the unified neural network.

FIG. 7 illustrates a method for determining a planning trajectory for an ego vehicle using a unified neural network.

### DETAILED DESCRIPTION

Described are systems and methods for determining a planning trajectory for an ego vehicle using a unified neural network. As will be explained in greater detail throughout the specification, the unified neural network can model a distribution over multiple future trajectories for the ego vehicle and other road agents using the unified neural network architecture for prediction and planning. The system and method select the planning trajectory that minimizes the cost taking into account the safety and predicted probabilities.

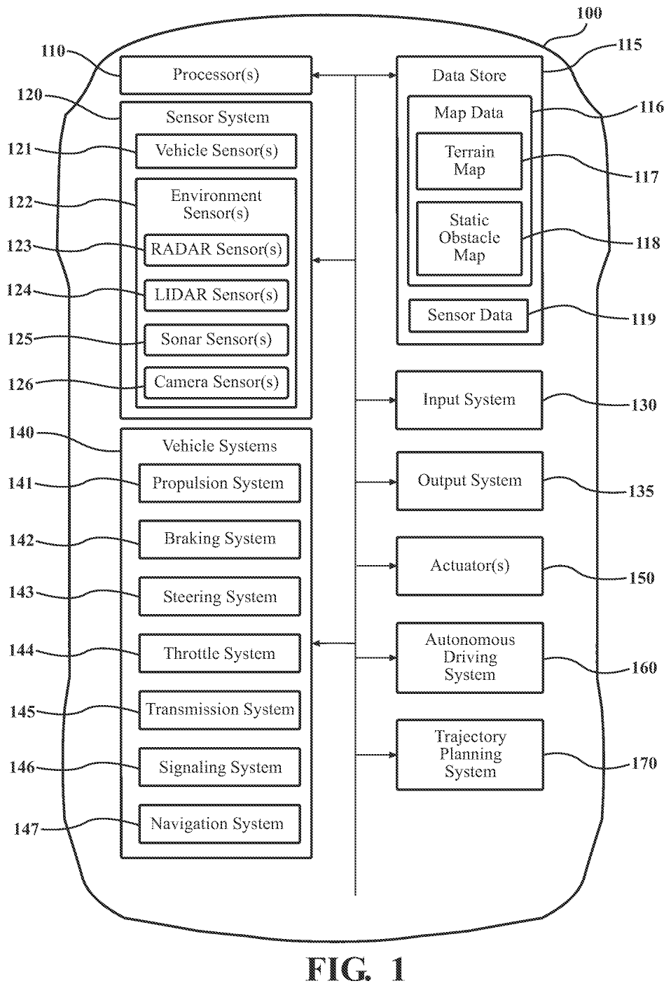

Referring to FIG. 1, an example of an ego vehicle 100 is illustrated. As used herein, a “vehicle” and/or “ego vehicle” is any form of powered transport. In one or more implementations, the ego vehicle 100 is an automobile. While arrangements will be described herein with respect to automobiles, it will be understood that embodiments are not limited to automobiles. In some implementations, the ego vehicle 100 may be any robotic device or form of powered transport that, for example, includes one or more automated or autonomous systems, thus benefiting from the functionality discussed herein.

In various embodiments, the automated/autonomous systems or combination of systems may vary. For example, in one aspect, the automated system is a system that provides autonomous control of the vehicle according to one or more levels of automation, such as the levels defined by the Society of Automotive Engineers (SAE) (e.g., levels 0-5). As such, the autonomous system may provide semi-autonomous or fully autonomous control, as discussed in relation to an autonomous driving system 160.

The ego vehicle 100 also includes various elements. It will be understood that in various embodiments it may not be necessary for the ego vehicle 100 to have all of the elements shown in FIG. 1. The ego vehicle 100 can have any combination of the various elements shown in FIG. 1. Further, the ego vehicle 100 can have additional elements to those shown in FIG. 1. In some arrangements, the ego vehicle 100 may be implemented without one or more of the elements shown in FIG. 1. While the various elements are shown as being located within the ego vehicle 100 in FIG. 1, it will be understood that one or more of these elements can be located external to the ego vehicle 100. Further, the elements shown may be physically separated by large distances and provided as remote services (e.g., cloud-computing services).

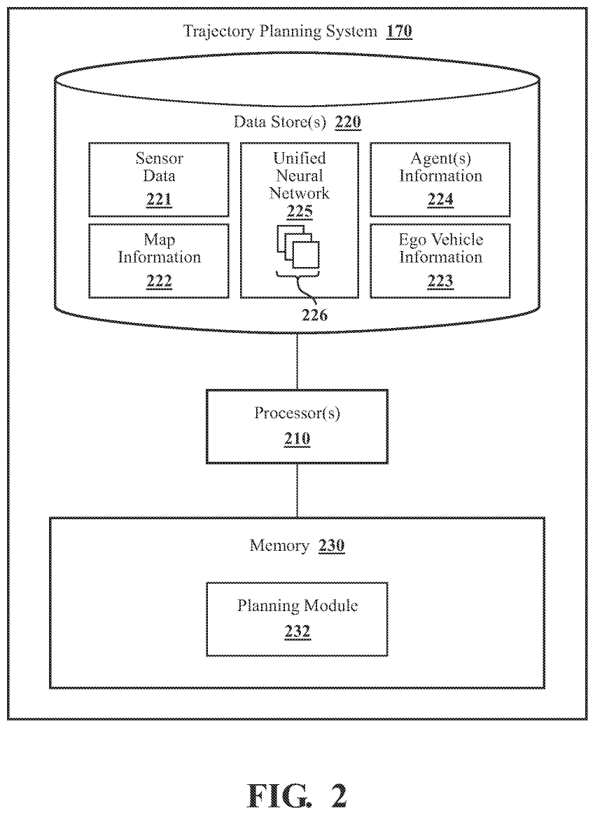

Some of the possible elements of the ego vehicle 100 are shown in FIG. 1 and will be described along with subsequent figures. However, a description of many of the elements in FIG. 1 will be provided after the discussion of FIGS. 2-7 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

Either way, the ego vehicle 100 includes a trajectory planning system 170. The trajectory planning system 170 may be incorporated within the autonomous driving system 160 or separately, as shown. As will be explained in greater detail throughout this description, the trajectory planning system 170 may incorporate the unified neural network and model a distribution over multiple future trajectories for the ego vehicle and other road agents using the unified neural network architecture for prediction and planning.

With reference to FIG. 2, one embodiment of the trajectory planning system 170 is further illustrated. As shown, the trajectory planning system 170 includes one or more processor(s) 210. Accordingly, the processor(s) 210 may be a part of the trajectory planning system 170 or the trajectory planning system 170 may access the processor(s) 210 through a data bus or another communication path. For example, the processor(s) 210 may be one or more other processors located within the ego vehicle 100, such as processor(s) 110.

In one or more embodiments, the processor(s) 210 is an application-specific integrated circuit that is configured to implement functions associated with a planning module 232. In general, the processor(s) 210 is an electronic processor, such as a microprocessor, capable of performing various functions described herein. In one embodiment, the trajectory planning system 170 includes a memory 230 that stores the planning module 232. The memory 230 may be a random-access memory (RAM), read-only memory (ROM), a hard disk drive, a flash memory, or other suitable memory for storing the planning module 232. The planning module 232 is, for example, computer-readable instructions that, when executed by the processor(s) 210, cause the processor(s) 210 to perform the various functions disclosed herein.

Furthermore, in one embodiment, the trajectory planning system 170 includes one or more data store(s) 220. The data store(s) 220 is, in one embodiment, an electronic data structure such as a database that is stored in the memory 230 or another memory and that is configured with routines that can be executed by the processor(s) 210 for analyzing stored data, providing stored data, organizing stored data, and so on. Thus, in one embodiment, the data store(s) 220 stores data used by planning module 232 in executing various functions.

In one embodiment, the data store(s) 220 includes sensor data 221, along with, for example, other information used by the planning module 232. The sensor data 221 may include some or all of the sensor data 119 shown in FIG. 1 and described later in this disclosure. In addition, the data store(s) 220 may also store the map information 222, ego vehicle information 223, an agent(s) information 224.

The map information 222 may include a static map, such as a static high-definition map, which includes map-related features, such as lanes, crosswalks, intersections, and the like. In addition, the map information 222 may also include dynamic map elements such as nonmoving obstacles and the status of traffic lights.

The ego vehicle information 223 can include information specifically regarding the ego vehicle 100. In one example, the ego vehicle information may include the current pose, speed, acceleration, size, moving/stationary history for Kₛ seconds, goal (route) as the center of the lane that the ego vehicle 100 should follow, and the like. As to the agent(s) information 224, this information can include information regarding different dynamic agents located near the ego vehicle, such as other vehicles, pedestrians, small motorized vehicles, animals, and the like. In one example, for each agent, the agent(s) information 224 may include information such as pose, size, vehicle type for the current frame, and/or moving/stationary history for K_{A} seconds.

The data store(s) 220 may also include a unified neural network 225. Essentially, the unified neural network 225 can model a distribution over multiple future trajectories for the ego vehicle 100 and other nearby road agents. The unified neural network 225 may include one or more model weights 226 that can be adjusted during the training of the unified neural network 225. In one example, the unified neural network 225 may be trained by utilizing an imitation learning technique that utilizes real-world examples of observations to train the unified neural network 225. During the training of the unified neural network 225, the model weights 226 are adjusted. Over time, the model weights 226 are adjusted such that they optimize the output of the unified neural network 225.

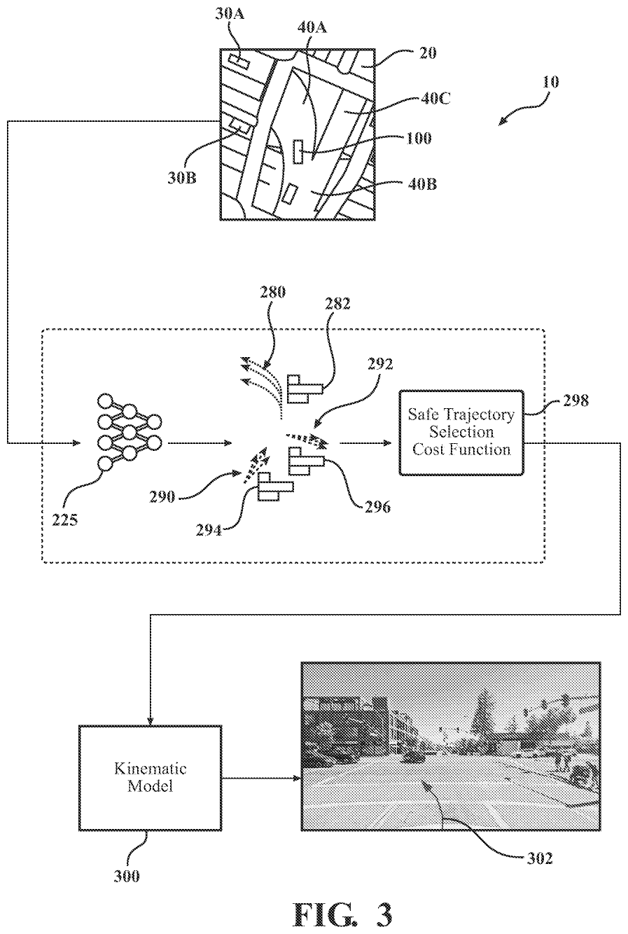

Before describing the details of the unified neural network 225, reference is made to FIG. 3, which illustrates a process flow 10 that provides a broad overview of how the trajectory planning system 170 can predict and appropriately plan a trajectory for the ego vehicle 100 to execute. Accordingly, the planning module 232 may include instructions that allow the trajectory planning system 170 to execute one or more methods similar to the process flow 10.

In one example, a map 20, which may be found within the map information 222 stored within the data store(s) 220, may include map-related features, such as lanes 40A-40C. As explained previously, the map-related features are not limited to roads and lanes but can include other map-related features such as crosswalks, intersections, and the like. In addition, the map 20 may also include dynamic map elements such as nonmoving obstacles and the status of traffic lights.

Also illustrated are the ego vehicle 100 and agents 30A and 30B, which are shown to be other vehicles but can be other moving objects, such as pedestrians, small motorized vehicles, animals, and the like. Information regarding the ego vehicle 100 may be stored as the ego vehicle information 223 and, as described earlier, can include information about the ego vehicle 100 such as the current pose, speed, acceleration, size, moving/stationary history for Kₛ seconds, goal (route) as the center of the lane that the ego vehicle 100 should follow, and the like. Information regarding the agents 30A and 30B can include information stored in the agent(s) information 224, such as pose, size, vehicle type for the current frame, and/or moving/stationary history for K_{A} seconds for each agent.

The map information 222, the ego vehicle information 223, and the agent(s) information 224 are then provided to the unified neural network 225. Broadly, the unified neural network 225 outputs the future ego vehicle trajectories 280 for the ego vehicle 100 and future agent trajectories 290 and 292 for the agents 30A and 30B, respectively. Additionally, the unified neural network 225 also outputs the probability distributions 282 for the future ego vehicle trajectories 280 and probability distributions 294 and 296 for the future agent trajectories 290 and 292, respectively.

The trajectories 280 for the ego vehicle 100 may include one or more trajectories determined by the unified neural network 225 as a possible trajectory for the ego vehicle 100 to utilize. The probability distributions 282 provide a probability for each of the trajectories 280 that the ego vehicle 100 should most likely execute. The greater the probability, the greater the likelihood that the ego vehicle 100 should execute a particular trajectory.

Similarly, the future agent trajectories 290 and 292 for the agents 30A and 30B, respectively, include one or more trajectories determined by the unified neural network 225 that the agents 30A and 30B are likely to utilize. The likelihood of one trajectory being utilized by the agents 30A and 30B are represented by the probability distributions 294 and 296, respectively.

The trajectories 280, 290, and 292, as well as the probability distributions 282, 294, and 296, are provided to a safe trajectory selection cost function 298 that can select which of the trajectories 280 the ego vehicle 100 should execute. As will be explained later in this description, the safe trajectory selection cost function 298 can perform a collision check between the future ego vehicle trajectories 280 and the future agent trajectories 290 and 292 to determine which of the future ego vehicle trajectories 280 are either collision-free and/or occur in a future predicted horizon. More simply, the safe trajectory selection cost function 298 selects a trajectory for the ego vehicle 100 that either does not result in a predicted collision with one of the agents 30A and/or 30B or selects a trajectory for the ego vehicle 100 that predicts a collision somewhere further off into the future. Selecting a collision that occurs furthest off into the future may allow the trajectory planning system 170 to utilize additional future information to predict and select another trajectory that can avoid any collision. The selected trajectory can then be provided to a kinematic model 300 that can translate into a set of control inputs that can be provided to one or more elements of the ego vehicle 100 to cause the ego vehicle 100 to execute the selected trajectory 302.

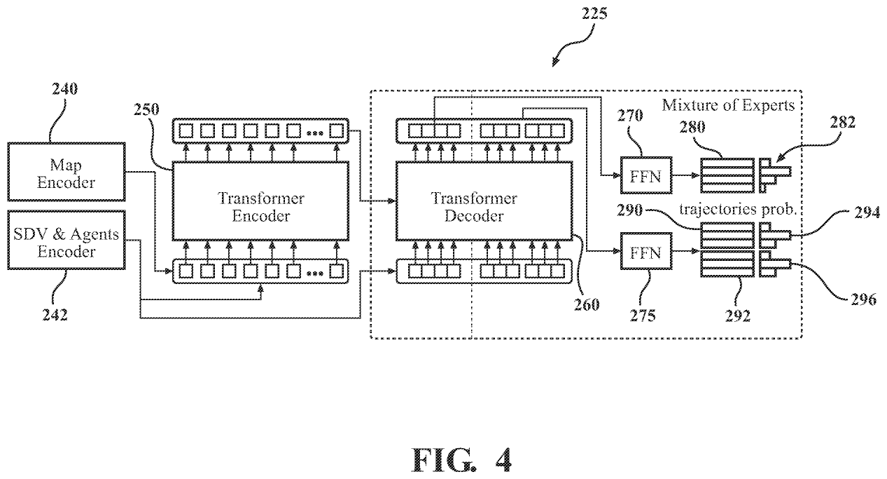

Now that a brief overview of how a particular trajectory is selected for the ego vehicle has been provided, reference is now made to FIG. 4, which illustrates one embodiment of the unified neural network 225. The unified neural network 225 addresses the joint tasks of prediction and planning. The unified neural network 225 models the multimodal trajectory distribution using a Mixture of Experts approach. However, it should be understood that the Mixture of Experts approach is but one method to model uncertainty that may be utilized. For example, other methods to model uncertainty can be used, such as Gaussian Mixtures or any suitable methodology. Moreover, the unified neural network 225 predicts different trajectory candidates (i.e., trajectories 280, 290, and 292) and probability distributions (i.e., probability distributions 282, 294, and 296) over them. The unified neural network 225 takes advantage of these planning alternatives defining a selection policy to improve driving safety at inference time.

The inputs provided to unified neural network 225, which may include the map information 222, the ego vehicle information 223, and the agent(s) information 224, may be in a vectorized format. As mentioned, the ego vehicle information 223 can include current pose, speed, acceleration, size, moving/stationary history for K_{S} seconds, and goal (route) as the center of the lane that the ego vehicle 100 should follow. The agent(s) information 224, for each agent, can include pose, size, vehicle type for the current frame, and/or moving/stationary history for K_{A} seconds. The map information 222 may be a static high-definition map including lanes, crosswalks, intersections, and/or dynamic map elements, including other nonmoving obstacles and the status of traffic lights. Each input element points are encoded in an ego vehicle 100-centric reference frame and include the element type as an additional feature.

As mentioned before, the outputs to the unified neural network 225 can include the future ego vehicle trajectories 280 and associated probability distributions 282, as well as the future agent trajectories 290 and 292 and associated probability distributions 294 and 296, respectively. Moreover, regarding the ego vehicle, the planning output is composed of N ego vehicle future trajectories τⁱ and one probability distribution pᵢ=p(τⁱ|x). Each ego vehicle trajectory τⁱ is defined as a set of Ts discrete states

τₜⁱ={xₜⁱ, yₜⁱ, θₜⁱ, vₜⁱ, aₜⁱ, kₜⁱ, jₜⁱ}, (1)

where t represents a timestep in the range [1, T_{A}], x, y, θ the pose, v the speed, a the acceleration, k the curvature, and j the jerk. In practice, the model outputs the jerk and curvature kₜⁱ, jₜⁱ for each timestep t, and the remaining trajectory features are inferred using a kinematic vehicle model (e.g., unicycle) from the initial statex₀ⁱ, y₀ⁱ, θ₀ⁱ [symbol] . The probability distribution pᵢ=p(τᵢ|x) is defined over the N ego vehicle future trajectories τⁱ and can be used to pick the most appropriate one given the current input.

The prediction output is composed of A×M road agents' future trajectories vₐ^{j}, j=1, . . . M and A probability distributions qⱼ^{a}=p(vₐ^{j}|x) over each set of agent M future trajectories vₐ^{j}. Each road agent trajectory vi is instead defined as a set of T a discrete states

vₜ^{j}={xₜ^{j}, yₜ^{j}, θₜ^{j}}, (2)

where t represents a timestep in the range [1, Tₐ] and x, y, θ represent the pose. Similar to the planning output, each probability distribution q^{a}, a=1, . . . A is defined over the M trajectories of the a-th agent. The distribution can pick the most appropriate trajectory for each agent. As to the architecture of the unified neural network 225, the architecture combines an element-wise point encoder and a transformer. In one of many possible implementations, the element-wise point encoder consists of neural networks (e.g., PointNet-like encoders) 240 and 242 that compress each input element from a set of points to a single feature vector of the same size. A series of Transformer Encoder layers 250 are used to model the relationships between all input elements (such as map information 222, ego vehicle information 223, and agent(s) information 224), encoded by the PointNet-like encoders 240 and 242. A series of Transformer Decoders 260 are used to query ego vehicle and agents features. The Transformer Decoders 260 may use a set of learnable embeddings to construct the queries. The ego vehicle embeddings from the point encoder are added to the set of N learnable embeddings to obtain a different query for each ego vehicle future trajectory predicted. Similarly, M learnable query embeddings are used to obtain a variable number of M different queries for each road agent. Each query embedding can encode a specific driving behavior corresponding to one expert of the Mixture of Experts approach or whatever method is utilized to model uncertainty.

An ego vehicle-specific decoder feed-forward network 270 converts each ego vehicle feature to a set of control inputs (i.e., jerk, curvature), and a kinematic decoder, such as kinematic model 300 of FIG. 3, translates them into a future trajectory. Similarly, an agent-specific decoder feed-forward network 275 converts each agent's future trajectories. Additionally, the ego vehicle-specific decoder feed-forward network 270 and agent-specific decoder feed-forward network 275 predict a logit for each ego vehicle and agent trajectory. For each element, the corresponding logits are converted to probability distributions 282, 294, and 296 over the future trajectories by applying a SoftMax function. All road agents and the ego vehicle are modeled independently but predicted jointly in parallel.

As to training the unified neural network 225, imitation may be utilized. The training objective may be defined as minimizing the distance between predicted ego vehicle poses and ground truth expert trajectories. Similarly, distances between predicted and ground truth agents' future trajectories may be minimized. Jerk and curvature may also additionally be regularized corresponding to ego vehicle plans.

The unified neural network 225 represents a Mixture of Experts and predicts multiple trajectories for the ego vehicle and each road agent, corresponding to N/M experts, and a probability distribution over each trajectory set, corresponding to expert selection. To train the experts and expert selection jointly while avoiding mode collapse, a winner takes all approach may be utilized. A matching cost may be formulated between predicted and target trajectories and probabilities, making the expert with the minimum cost the winner. Broadly, the loss is applied to one sample of the ego vehicle planning, which is similarly applied to the agent prediction.

A matching cost may be computed for each trajectory, and a selection of one trajectory may be made according to the following:

$${i}^{*} = arg min {ℒ}_{IL}^{i} + λ ( 1 - {p}_{i} ) \qquad ( 3 )$$

$${ℒ}_{IL}^{i} = {\sum }_{t = 1}^{T} {‖ {τ}_{t}^{i} - {\hat{τ}}_{t} ‖}_{1} + {βℒ}_{reg}^{i}$$

where pi is the predicted probability for the trajectory τⁱ, \hat{τ} is the ground truth trajectory, λ and β are weighting factors, and [symbol] _{reg} is a regularization loss. The loss is minimized as follows:

[symbol]

= [symbol] _{IL}^{i*}+μ [symbol] _{NLL}^{i*}, where [symbol] _{NLL}^{i*}=−log p_{i*} (4)

that takes into account the selected trajectory τ^{i*} and combines the imitation and the matching loss.

At inference time, the diverse predicted trajectories τⁱ are leveraged to compute the cost cᵢ of executing each of them. The trajectory

$$\hat{i} = arg {min}_{i} {c}_{i}$$

with the minimum cost is then selected.

There are a number of different ways that minimum cost can be determined. In one example, given the predicted ego vehicle trajectories and the associated probabilities, the cost can be negatively proportional to the predicted probability: cᵢ=−pᵢ. However, this approach ignores other road agents' future locations and thus may lead to collisions, as models can still predict colliding trajectories even when trained with auxiliary collision losses.

As an alternative, the predicted ego vehicle trajectory distribution and agents' predictions can be leveraged instead. For example, a collision check between each future ego vehicle trajectory τⁱ and the most probable predicted agents' locations v^{j*} by means of overlap between their bounding boxes. In one example, the cost function may utilize a Separating Axis Theorem (SAT) for efficient computation. Then, the cost defined previously may be extended by adding a cost for any potential collision with other agents:

cᵢ=−pᵢ−αt̅ᵢ (5)

where α is a fixed penalty term and t̅ᵢ is the timestep of the first predicted collision. In other words, ego vehicle trajectories predicted to collide with road agents' most probable futures are penalized. If the predicted set of trajectories contains at least one collision-free trajectory or trajectories with collisions further ahead in the predicted horizon, then the presented approach can improve the safety of the planner.

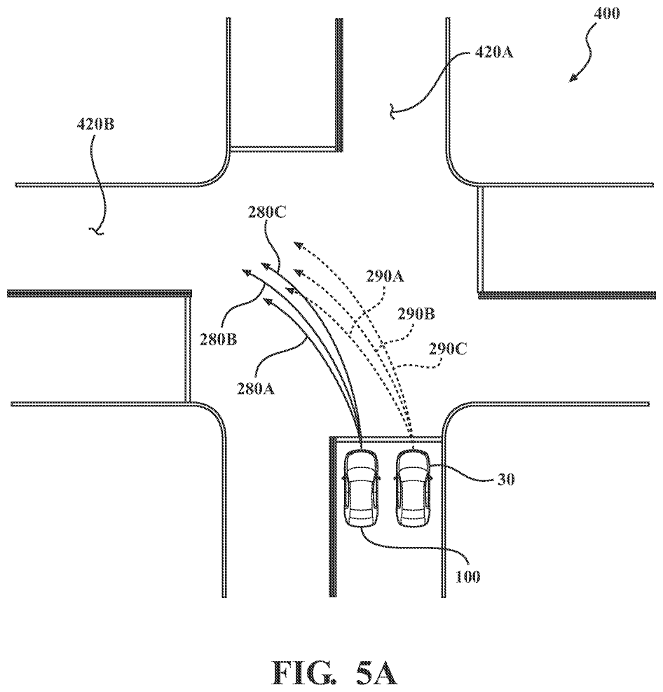

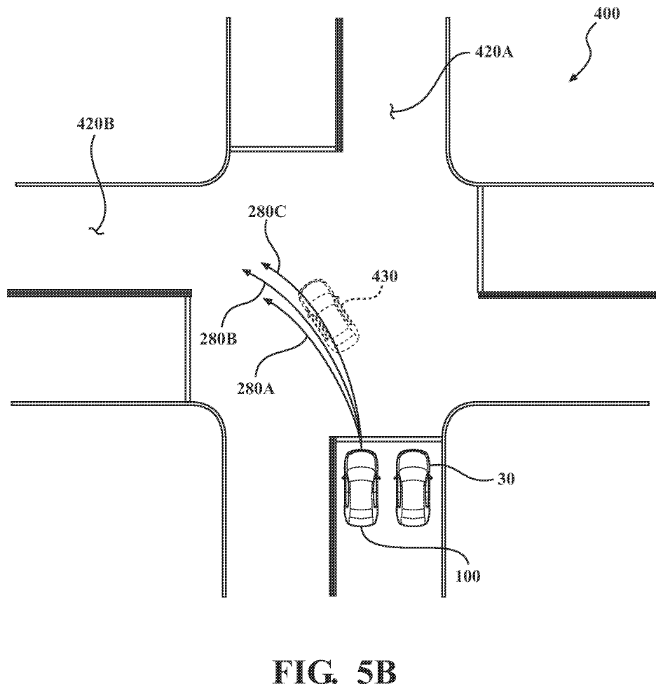

To better visualize how the collision check functions, reference is made to FIGS. 5A and 5B. Here, illustrated is a scenario 400, with roads 420A and 420B forming an intersection. The roads 420A and 420B may each include one or more lanes. Also located in the scenario 400 is the ego vehicle 100 and agent 30 in the form of another vehicle. In this example, assume both the ego vehicle 100 in the agent 30 wish to turn left from the road 420A and onto the road 420B. The ego vehicle 100 includes the trajectory planning system 170 that determines future ego vehicle trajectories 280A-280C and future agent trajectories 290A-290C. While not shown, the trajectory planning system 170 also determines probabilities for the future ego vehicle trajectories 280A-280C and the future agent trajectories 290A-290C.

With particular attention to FIG. 5B, the collision check described above can utilize future agent trajectories 290A-290C and associated probabilities to determine the locations of the agent if they are assumed to follow the future agent trajectories 290A-290C. In this example, a bounding box 430 is shown to represent the location of the agent 30 if the agent follows future agent trajectory 290A. As can be seen, the bounding box 430 represents the location of the agent 30. If the agent follows future agent trajectory 290A, it will interfere with the trajectory 280C. In this case, the collision check would apply an additional cost to utilizing the trajectory 280C by the ego vehicle 100, making it more likely that the ego vehicle 100 utilizes the trajectories 280A or 280B. Most likely, 280A being furthest from the bounding box 430 would be weighted most favorably.

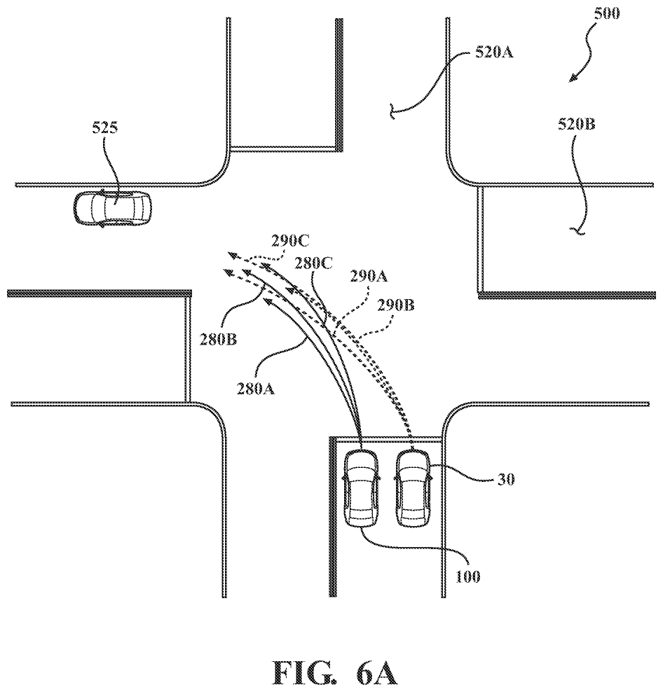

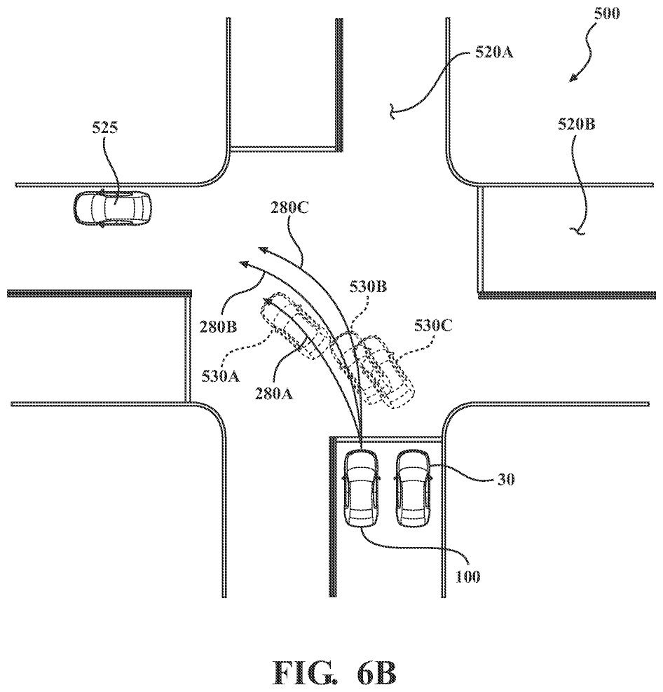

FIGS. 6A and 6B illustrate another example of how the collision check functions. Here, the scenario 500 includes roads 520A and 520B. Like before, the ego vehicle 100 and the agent 30 intend to turn left from the road 520A onto the road 520B. Here, the scenario 500 also includes an object 525 that blocks one lane of the road 520B, essentially forcing the agent 30 to utilize the same lane as the ego vehicle 100. Like before, the trajectory planning system 170 of the ego vehicle determines future ego vehicle trajectories 280A-280C and future agent trajectories 290A-290C. However, because the object 525 blocks one lane on the road 520B, it can be observed that many of the future agent trajectories 290A-290C will overlap the future ego vehicle trajectories 280A-280C.

FIG. 6B illustrates the scenario 500, wherein the collision check has created bounding boxes 530A-530C for each of the future agent trajectories 290A-290C. Like before, the bounding boxes 530A-530C represent the future positions of the agent 30 when following the future agent trajectories 290A-290C. Here, no matter which of the future ego vehicle trajectories 280A-280C the ego vehicle 100 utilizes, it is predicted that the ego vehicle 100 will collide with the agent as indicated by the position of the bounding boxes 530A-530C with respect to the future ego vehicle trajectories 280A-280C.

In this case, the cost function applies a higher cost to the trajectories 280B and 280C because they will result in a probable collision before the trajectory 280A. As such, the cost will be adjusted such that the trajectory 280A will be selected as that trajectory would result in a collision at the most future times step. Ultimately, as the ego vehicle 100 and agent 30 follow their trajectories, the trajectory planning system 170 will receive additional information that can update itself to determine a trajectory that will avoid a collision. By choosing a trajectory that delays a collision furthest into the future, additional time and information can be provided to the trajectory planning system 170 to avoid a collision altogether.

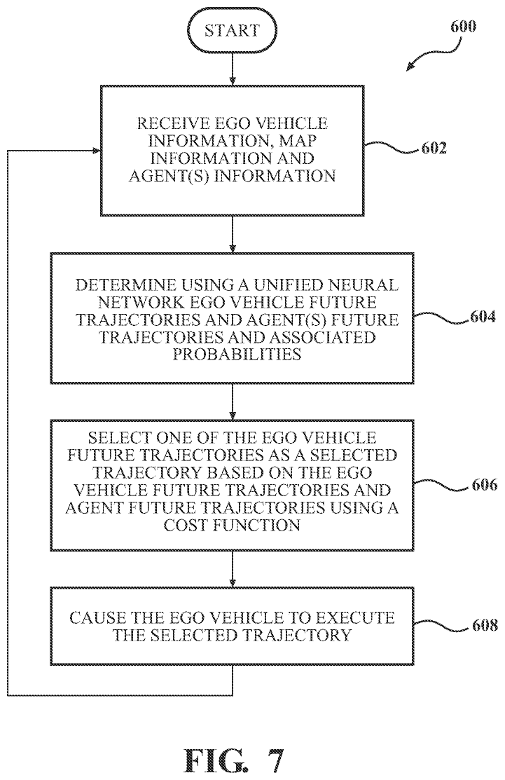

Referring to FIG. 7, a method 600 for determining a planning trajectory for an ego vehicle is shown. The method 600 will be described from the viewpoint of the ego vehicle 100 of FIG. 1 and the trajectory planning system 170 of FIG. 2. However, it should be understood that this is just one example of implementing the method 600. While method 600 is discussed in combination with the trajectory planning system 170, it should be appreciated that the method 600 is not limited to being implemented within the trajectory planning system 170, but is instead one example of a system that may implement the method 600.

In step 602, the planning module 232 causes the processor(s) 210 of the trajectory planning system 170 to receive ego vehicle information 223, agent(s) information 224, and map information 222. In some cases, the agent(s) information 224 may be derived from sensor data 221 collected from one or more of the vehicle sensors of the ego vehicle 100. The map information 222 may include a static map, such as a static high-definition map, which includes map-related features, such as lanes, crosswalks, intersections, and the like. In addition, the map information 222 may also include dynamic map elements such as nonmoving obstacles and the status of traffic lights. The ego vehicle information 223 can include information specifically regarding the ego vehicle 100. In one example, the ego vehicle information may include the current pose, speed, acceleration, size, moving/stationary history for Kₛ seconds, goal (route) as the center of the lane that the ego vehicle 100 should follow, and the like. As to the agent(s) information 224, this information can include information regarding different dynamic agents located near the ego vehicle, such as other vehicles, pedestrians, small motorized vehicles, animals, and the like. In one example, for each agent, the agent(s) information 224 may include information such as pose, size, vehicle type for the current frame, and/or moving/stationary history for K_{A} seconds.

In step 604, the planning module 232 causes the processor(s) 210 to determine using a mixture of experts in a unified neural network, such as the unified neural network 225, ego vehicle trajectories, and agent(s) future trajectories and associated probabilities. Again, other methods may be utilized to model uncertainty and not just mixture of experts. As mentioned before, the unified neural network 225 outputs future ego vehicle trajectories for the ego vehicle 100 and future agent trajectories for any agents. Additionally, the unified neural network 225 also outputs probabilities for the future ego vehicle trajectories and probabilities for the future agent trajectories.

In step 606, the planning module 232 causes the processor(s) 210 to select one of the ego vehicle future trajectories as a selected trajectory based on the ego vehicle future trajectories and agent future trajectories using a cost function. As explained previously, the cost function may essentially utilize a collision check between each future ego vehicle trajectory τⁱ and the most probable predicted agents' locations v^{j*} by means of overlap between their bounding boxes. More simply, ego vehicle trajectories are penalized that are predicted to collide with road agents' most probable futures. If the predicted set of trajectories contains at least one collision-free trajectory or trajectories with collisions further ahead in the predicted horizon, then the presented approach can improve the safety of the planner.

In step 608, the planning module 232 causes the processor(s) 210 to control the ego vehicle 100 to execute the selected trajectory. In one example, the planning module 232 causes the processor(s) 210 to interact with the vehicle systems 140 to control the braking, propulsion, throttle, steering, or other systems of the ego vehicle 100, such that the ego vehicle 100 executes the selected trajectory.

FIG. 1 will now be discussed in full detail as an example environment within which the system and methods disclosed herein may operate. In one or more embodiments, the ego vehicle 100 is an autonomous vehicle. As used herein, “autonomous vehicle” refers to a vehicle that operates in an autonomous mode. “Autonomous mode” refers to navigating and/or maneuvering the ego vehicle 100 along a travel route using one or more computing systems to control the ego vehicle 100 with minimal or no input from a human driver. In one or more embodiments, the ego vehicle 100 is highly automated or completely automated. In one embodiment, the ego vehicle 100 is configured with one or more semi-autonomous operational modes in which one or more computing systems perform a portion of the navigation and/or maneuvering of the ego vehicle 100 along a travel route, and a vehicle operator (i.e., driver) provides inputs to the vehicle to perform a portion of the navigation and/or maneuvering of the ego vehicle 100 along a travel route. Such semi-autonomous operation can include supervisory control implemented by the trajectory planning system 170 to ensure the ego vehicle 100 remains within defined state constraints.

The ego vehicle 100 can include one or more processor(s) 110. In one or more arrangements, the processor(s) 110 can be a main processor of the ego vehicle 100. For instance, the processor(s) 110 can be an electronic control unit (ECU). The ego vehicle 100 can include one or more data store(s) 115 for storing one or more types of data. The data store(s) 115 can include volatile and/or non-volatile memory. Examples of data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operatively connected to the processor(s) 210 for use thereby. The term “operatively connected,” as used throughout this description, can include direct or indirect connections, including connections without direct physical contact.

In one or more arrangements, the one or more data store(s) 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain map(s) 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle map(s) 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, and hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data store(s) 115 can include sensor data 119. In this context, “sensor data” means any information about the sensors that the ego vehicle 100 is equipped with, including the capabilities and other information about such sensors. As explained below, the ego vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data store(s) 115 located onboard the ego vehicle 100. Alternatively, or in addition, at least a portion of the map data 116 and/or the sensor data 119 can be located in one or more data store(s) 115 that are located remotely from the ego vehicle 100.

As noted above, the ego vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 210, the data store(s) 115, and/or another element of the ego vehicle 100 (including any of the elements shown in FIG. 1). The sensor system 120 can acquire data of at least a portion of the external environment of the ego vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensor(s) 121. The vehicle sensor(s) 121 can detect, determine, and/or sense information about the ego vehicle 100 itself. In one or more arrangements, the vehicle sensor(s) 121 can be configured to detect, and/or sense position and orientation changes of the ego vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the ego vehicle 100. In one or more arrangements, the vehicle sensor(s) 121 can include a speedometer to determine a current speed of the ego vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the ego vehicle 100 and/or information/data about such obstacles. Such obstacles may be stationary objects and/or dynamic objects. The one or more environment sensors 122 can be configured to detect, measure, quantify and/or sense other things in the external environment of the ego vehicle 100, such as, for example, lane markers, signs, traffic lights, traffic signs, lane lines, crosswalks, curbs proximate the ego vehicle 100, off-road objects, etc.

Various examples of sensors of the sensor system 120 will be described herein. The example sensors may be part of the one or more environment sensors 122 and/or the one or more vehicle sensor(s) 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The ego vehicle 100 can include an input system 130. An “input system” includes any device, component, system, element or arrangement or groups thereof that enable information/data to be entered into a machine. The input system 130 can receive an input from a vehicle passenger (e.g., a driver or a passenger). The ego vehicle 100 can include an output system 135. An “output system” includes any device, component, arrangement, or group that enables information/data to be presented to a vehicle passenger (e.g., a person, a vehicle passenger, etc.).

The ego vehicle 100 can include one or more vehicle systems 140. Various examples of the one or more vehicle systems 140 are shown in FIG. 1. However, the ego vehicle 100 can include more, fewer, or different vehicle systems. It should be appreciated that although particular vehicle systems are separately defined, each or any of the systems or portions thereof may be otherwise combined or segregated via hardware and/or software within the ego vehicle 100. The ego vehicle 100 can include a propulsion system 141, a braking system 142, a steering system 143, a throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the ego vehicle 100 and/or to determine a travel route for the ego vehicle 100. The navigation system 147 can include one or more mapping applications to determine a travel route for the ego vehicle 100. The navigation system 147 can include a global positioning system, a local positioning system, or a geolocation system.

The processor(s) 110, the trajectory planning system 170, and/or the autonomous driving system 160 can be operatively connected to communicate with the vehicle systems 140 and/or individual components thereof. For example, returning to FIG. 1, the processor(s) 110 and/or the autonomous driving system 160 can be in communication to send and/or receive information from the vehicle systems 140 to control the movement, speed, maneuvering, heading, direction, etc. of the ego vehicle 100. The processor(s) 110, the trajectory planning system 170, and/or the autonomous driving system 160 may control some or all of these vehicle systems 140 and, thus, may be partially or fully autonomous.

The processor(s) 110, the trajectory planning system 170, and/or the autonomous driving system 160 can be operatively connected to communicate with the vehicle systems 140 and/or individual components thereof. For example, returning to FIG. 1, the processor(s) 110, the trajectory planning system 170, and/or the autonomous driving system 160 can be in communication to send and/or receive information from the vehicle systems 140 to control the movement, speed, maneuvering, heading, direction, etc. of the ego vehicle 100. The processor(s) 110, the trajectory planning system 170, and/or the autonomous driving system 160 may control some or all of these vehicle systems 140.

The processor(s) 110, the trajectory planning system 170, and/or the autonomous driving system 160 may be operable to control the navigation and/or maneuvering of the ego vehicle 100 by controlling one or more of the vehicle systems 140 and/or components thereof. For instance, when operating in an autonomous mode, the processor(s) 110, the trajectory planning system 170, and/or the autonomous driving system 160 can control the direction and/or speed of the ego vehicle 100. The processor(s) 110, the trajectory planning system 170, and/or the autonomous driving system 160 can cause the ego vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either directly or indirectly.

The ego vehicle 100 can include one or more actuators 150. The actuators 150 can be any element or combination of elements operable to modify, adjust and/or alter one or more of the vehicle systems 140 or components thereof to respond to receiving signals or other inputs from the processor(s) 110 and/or the autonomous driving system 160. Any suitable actuator can be used. For instance, the one or more actuators 150 can include motors, pneumatic actuators, hydraulic pistons, relays, solenoids, and/or piezoelectric actuators, just to name a few possibilities.

The ego vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store(s) 115 may contain such instructions.

In one or more arrangements, one or more of the modules described herein can include artificial or computational intelligence elements, e.g., neural networks, fuzzy logic, or other machine learning algorithms. Further, in one or more arrangements, one or more of the modules can be distributed among a plurality of the modules described herein. In one or more arrangements, two or more of the modules described herein can be combined into a single module.

The ego vehicle 100 can include an autonomous driving system 160. The autonomous driving system 160 can be configured to receive data from the sensor system 120 and/or any other type of system capable of capturing information relating to the ego vehicle 100 and/or the external environment of the ego vehicle 100. In one or more arrangements, the autonomous driving system 160 can use such data to generate one or more driving scene models. The autonomous driving system 160 can determine position and velocity of the ego vehicle 100. The autonomous driving system 160 can determine the location of obstacles, obstacles, or other environmental features, including traffic signs, trees, shrubs, neighboring vehicles, pedestrians, etc.

The autonomous driving system 160 can be configured to receive and/or determine location information for obstacles within the external environment of the ego vehicle 100 for use by the processor(s) 110 and/or one or more of the modules described herein to estimate position and orientation of the ego vehicle 100, vehicle position in global coordinates based on signals from a plurality of satellites, or any other data and/or signals that could be used to determine the current state of the ego vehicle 100 or determine the position of the ego vehicle 100 with respect to its environment for use in either creating a map or determining the position of the ego vehicle 100 in respect to map data.

The autonomous driving system 160, either independently or in combination with the trajectory planning system 170, can be configured to determine travel path(s), current autonomous driving maneuvers for the ego vehicle 100, future autonomous driving maneuvers and/or modifications to current autonomous driving maneuvers based on data acquired by the sensor system 120, driving scene models, and/or data from any other suitable source such as determinations from the sensor data 221 as implemented by planning module 232. “Driving maneuver” means one or more actions that affect the movement of a vehicle. Examples of driving maneuvers include accelerating, decelerating, braking, turning, moving in a lateral direction of the ego vehicle 100, changing travel lanes, merging into a travel lane, and/or reversing, just to name a few possibilities. The autonomous driving system 160 can be configured to implement determined driving maneuvers. The autonomous driving system 160 can cause, directly or indirectly, such autonomous driving maneuvers to be implemented. As used herein, “cause” or “causing” means to make, command, instruct, and/or enable an event or action to occur or at least be in a state where such event or action may occur, either directly or indirectly. The autonomous driving system 160 can be configured to execute various vehicle functions and/or to transmit data to, receive data from, interact with, and/or control the ego vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, when loaded in a processing system, can carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system for determining a planning trajectory for an ego vehicle, the system comprising:
a processor; and
a memory in communication with the processor, the memory having a planning module including instructions that, when executed by the processor, cause the processor to:
determine, using a unified neural network based on input information, ego vehicle future trajectories of the ego vehicle and agent future trajectories of one or more agents, wherein the ego vehicle future trajectories and the agent future trajectories have probability distributions,
select one of the ego vehicle future trajectories as a selected trajectory based on the ego vehicle future trajectories and agent future trajectories using a cost function, and
cause the ego vehicle to execute the selected trajectory.

2. The system of claim 1, wherein:
the input information includes map information, ego vehicle information, and agent information;
the map information includes road layout information;
the ego vehicle information includes at least one of pose, speed, acceleration, size, and moving history of the ego vehicle for a defined time period; and
the agent information includes at least one of pose, size, vehicle type for the current frame, and moving history of the one or more agents for a defined time period.

3. The system of claim 1, wherein the planning module further includes instructions that, when executed by the processor, cause the processor to:
perform a collision check between the ego vehicle future trajectories and predicted agent future locations to determine the ego vehicle future trajectories that at least one of collision-free or collision-probable in a predicted horizon; and
select one of the ego vehicle future trajectories as the selected trajectory that is either collision-free or collision-probable in the predicted horizon.

4. The system of claim 3, wherein the planning module further includes instructions that, when executed by the processor, cause the processor to extend a cost output by the cost function by adding a collision cost for any potential collision of the ego vehicle with the one or more agents based on the ego vehicle future trajectories and the predicted agent future locations.

5. The system of claim 1, wherein the unified neural network comprises an element-wise point encoder and a transformer.

6. The system of claim 1, wherein the unified neural network further comprises an agent feed-forward network and an ego vehicle feed-forward network, wherein the ego vehicle feed-forward network predicts the ego vehicle future trajectories and associated ego vehicle probability distributions, and the agent feed-forward network predicts the agent future trajectories and associated agent probability distributions.

7. The system of claim 1, wherein the unified neural network is trained using an imitation learning methodology or other suitable methodology.

8. A method for determining a planning trajectory for an ego vehicle, the method comprising the steps of:
determining, using a unified neural network based on input information, ego vehicle future trajectories of the ego vehicle and agent future trajectories of one or more agents, wherein the ego vehicle future trajectories and the agent future trajectories have probability distributions;
selecting one of the ego vehicle future trajectories as a selected trajectory based on the ego vehicle future trajectories and agent future trajectories using a cost function; and
causing the ego vehicle to execute the selected trajectory.

9. The method of claim 8, wherein:
the input information includes map information, ego vehicle information, and agent information;
the map information includes road layout information;
the ego vehicle information includes at least one of pose, speed, acceleration, size, and moving history of the ego vehicle for a defined time period; and
the agent information includes at least one of pose, size, vehicle type for the current frame, and moving history of the one or more agents for a defined time period.

10. The method of claim 8, further comprising steps of:
performing a collision check between the ego vehicle future trajectories and predicted agent future locations to determine the ego vehicle future trajectories that at least one of collision-free or collision-probable in a predicted horizon; and
selecting one of the ego vehicle future trajectories as the selected trajectory that is either collision-free or collision-probable in the predicted horizon.

11. The method of claim 10, further comprising the step of extending a cost output by the cost function by adding a collision cost for any potential collision of the ego vehicle with the one or more agents based on the ego vehicle future trajectories and the predicted agent future locations.

12. The method of claim 8, wherein the unified neural network comprises an element-wise point encoder and a transformer.

13. The method of claim 8, wherein the unified neural network further comprises an agent feed-forward network and an ego vehicle feed-forward network, wherein the ego vehicle feed-forward network predicts the ego vehicle future trajectories and associated ego vehicle probability distributions, and the agent feed-forward network predicts the agent future trajectories and associated agent probability distributions.

14. The method of claim 8, wherein the unified neural network is trained using an imitation learning methodology or other suitable methodology.

15. A non-transitory computer-readable medium including instructions that, when executed by a processor, cause the processor to:
determine, using a unified neural network based on input information, ego vehicle future trajectories of an ego vehicle and agent future trajectories of one or more agents, wherein the ego vehicle future trajectories and the agent future trajectories have probability distributions;
select one of the ego vehicle future trajectories as a selected trajectory based on the ego vehicle future trajectories and agent future trajectories using a cost function; and
cause the ego vehicle to execute the selected trajectory.

16. The non-transitory computer-readable medium of claim 15, wherein:
the input information includes map information, ego vehicle information, and agent information;
the map information includes road layout information;
the ego vehicle information includes at least one of pose, speed, acceleration, size, and moving history of the ego vehicle for a defined time period; and
the agent information includes at least one of pose, size, vehicle type for the current frame, and moving history of the one or more agents for a defined time period.

17. The non-transitory computer-readable medium of claim 15, further including instructions that, when executed by a processor, cause the processor to:
perform a collision check between the ego vehicle future trajectories and predicted agent future locations to determine the ego vehicle future trajectories that at least one of collision-free or collision-probable in a predicted horizon; and
select one of the ego vehicle future trajectories as the selected trajectory that is either collision-free or collision-probable in the predicted horizon.

18. The non-transitory computer-readable medium of claim 17, further including instructions that, when executed by a processor, cause the processor to extend a cost output by the cost function by adding a collision cost for any potential collision of the ego vehicle with the one or more agents based on the ego vehicle future trajectories and the predicted agent future locations.

19. The non-transitory computer-readable medium of claim 15, wherein the unified neural network comprises an element-wise point encoder and a transformer.

20. The non-transitory computer-readable medium of claim 15, wherein the unified neural network further comprises an agent feed-forward network and an ego vehicle feed-forward network, wherein the ego vehicle feed-forward network predicts the ego vehicle future trajectories and associated ego vehicle probability distributions and the agent feed-forward network predicts the agent future trajectories and associated agent probability distributions.
